(19) United States
(12) Patent Application Publication
(10) Pub. No.: US 2007/0288342 A1
(43) Pub. Date: Dec. 13, 2007

(54) Method and system for algorithmic crossing to minimize risk-adjusted costs of trading securities

(76) Inventors: Leon Maclin, New York, NY (US); David A. Mechner, New York, NY (US)

Correspondence Address: David A. Mechner;Pragma, 9th floor, 826 Broadway, New York, NY, 10003, US

(21) Appl. No.: 11/433,000

(22) Filed: May 13, 2006

(51) Int. Cl. G06Q 40/00

(52) U.S. Cl. 705/37

(57) ABSTRACT

The invention is a computer method and system that attempts to minimize the risk-adjusted cost of trading securities in a liquidity pool such as a crossing network or dark book. A mathematically optimal trade-out schedule or trajectory is used to remove shares incrementally over time from the liquidity pool and trade them out to other marketplaces. The trade-out schedule is optimal in that it minimizes the risk-adjusted cost of execution by considering factors such as a) the risk of failing to find a crossing counter-party for all or some of the quantity submitted to the liquidity pool and having to execute that quantity as a liquidity depleting order in other markets, b) the risk of adverse price movement, c) the expectation of adverse price movement, d) the cost of executing orders in other markets, and e) the potential cost savings of finding a cross in the liquidity pool. The quantity still remaining in the liquidity pool—the “reserve”—is available for crossing up to a specified discretionary limit.

### CROSS-REFERENCE TO RELATED APPLICATIONS

### RELATED U.S. PATENT DOCUMENTS

This application is based on and claims priority to provisional patent application No. 60/680,368 filed on May 12, 2005, the entire contents of which are incorporated herein by reference.

U.S. Patent Documents

| | | |
|---|---|---|
| 3,573,747 | April 1971 | Adams et al. |
| 5,101,353 | March 1992 | Lupien et al. |
| 5,136,501 | August 1992 | Silverman et al. |
| 5,148,365 | September 1992 | Dembo |
| 5,689,652 | November 1997 | Lupien et al. |
| 5,950,177 | September 1999 | Lupien et al. |
| 6,012,046 | January 2000 | Lupien et al. |
| 6,078,904 | June 2000 | Rebane |
| 6,405,180 | June 2002 | Tilfors et al. |
| 6,493,682 | December 2002 | Horrigan et al. |
| 6,968,318 | November 2005 | Ferstenberg et al. |
| 20030177126 | September 2003 | Weingard et al. |
| 20040111356 | June 2004 | Srivastava et al. |
| 20040177023 | September 2004 | Krowas et al. |
| 20050075963 | April 2005 | Balabon |

Foreign Patent Documents

| | | |
|---|---|---|
| EP1363223 | November 2003 | EP |
| WO2004086183 | October 2004 | WO |
| CA2521927 | November 2004 | CA |
| WO2005048063 | May 2005 | WO |
| WO2006031807 | March 2006 | WO |
| WO2006043979 | April 2006 | WO |

### OTHER REFERENCES

Almgren R, Chriss N (2001) Optimal execution of portfolio transactions. Journal of Risk 3:5-39.

### STATEMENT REGARDING FEDERALLY SPONSORED RESEARCH OR DEVELOPMENT

Not applicable.

### FIELD OF THE INVENTION

The present invention relates to the field of buying and selling securities or other fungible assets by means of a computerized exchange, and more particularly to executing trades in a crossing network, liquidity dark book, or similar liquidity pool in a manner that minimizes the expected risk-adjusted costs of trading, including the risk-adjusted costs that arise from exposing orders to the liquidity pool.

### BACKGROUND OF THE INVENTION

Stock Exchanges

In traditional stock exchanges, buyers and sellers cannot find each other without revealing information that, on average, increases the costs of trading for both sides. In other words, the markets could be more liquid than they are if there were a way to better match buyers and sellers.

Recent advances in experimental economics (See Paving Wall Street, Miller, 2002) have confirmed the real-world experiences of market participants. The structure of existing markets—such as the NYSE and electronic exchanges—penalizes all traders, but especially large ones, for revealing their intentions to trade. For example, when intention to trade is revealed by a buyer, sellers—some of whom may have planned to initiate trades—respond by switching to passive trading, thereby forcing the buyer to initiate trades and, in the process, incur a higher cost.

Hence, neither side has incentive to reveal its true trading intentions, with the result that both buyers and sellers trade in much smaller size than they otherwise would, and are both forced to pay a third party—such as a specialist or market-maker—for facilitating their trades. As many academic and industry studies have clearly shown, the cost of supporting an entire industry of middle-men represents a large fraction of the expected profits of trading.

There have been many attempts to solve the above problems. For example, on the New York Stock Exchange, it is common for specialists to accumulate many small orders in one direction before trading them with large, institutional orders in the other direction. This practice can be seen as an attempt to artificially create liquidity by making small traders pay for the liquidity provided to large traders. Moreover, traders still perceive a cost to revealing their trading intentions by placing large block orders in the NYSE.

Crossing Networks

Crossing networks are a new, alternative type of trading system which has greatly increased in popularity over the last five years. Crossing networks differ from traditional stock exchanges:
In traditional exchanges, an active buyer and an active seller must both pay the full spread, unless their orders happen to reach the top of the books at exactly the same instant. In crossing networks, both parties can meet at an agreed mid-spread price, effectively, each paying half the spread.
In crossing networks, trade size information is typically not published. Information about execution price has no impact on price quotes because executions typically occur at mid-quote. Crossing networks are thus less sensitive to information leakage.

As a result, crossing networks have gained favor with those who trade large blocks of stock. Such traders substantially reduce costs and increase profits for their trades that execute in crossing networks. Potentially, crossing networks can present all traders with a significant cost reduction.

Despite their advantages, crossing networks today are used to execute only a relatively small volume of trades. A key reason is that buy or sell orders placed into a crossing network wait idly until a counter-party arrives. This incurs price risk and opportunity cost. More importantly, it may force market participants to remove large orders that fail to cross from a crossing network and execute them in the open market when there is much less time left for the execution. Large compressed executions can be very costly.

Existing crossing network firms have tried to mitigate the risk cost. One strategy, which has helped, is to conduct crosses only during a few brief, preset times during the day. For example, ITG's POSIT attempts to cross trades at eight discrete crossing times in the trading day. All parties who want to try to cross must enter their orders at the same time. If matching counter-parties are found, their orders cross. The remaining uncrossed quantities are released and can be traded normally in a stock exchange.

This strategy improves the chances that matching counter-parties at the time of the cross but fails to take advantages of crossing opportunities that might arise between the preset crossing times. Crossing at a designated time is a way of artificially creating liquidity at the cost of risk and opportunity costs.

Another strategy is “scraping” dark books. Dark books are pools of liquidity whose contents are unpublished. A trader can place passive orders into a dark book. The orders stay in the dark book until matched against a counter-party's order or until withdrawn. Because the contents are unpublished, a trader using a dark book does not know beforehand whether or when an order will execute. The only way to tell is to place the order, and see whether it executes. Dark books use several rules, such as minimum size and minimum duration, to prevent traders from using small “probe” trades to discover the contents.

Scraping dark books means intercepting an active order on its way from a trader to an exchange, and first quickly checking one or more dark books for matching liquidity. Any matching quantities cross; unmatched quantities pass through immediately to the exchange. This strategy reduces execution costs for the crossed quantities, with essentially no delay for the remainder.

As with crossing networks such as Liquidnet and Pipeline, passive orders sit idly in a dark book, incurring risk and opportunity cost. Worse, active orders have only one, initial chance to cross and cannot take advantage of matching liquidity that might arrive in the crossing network after they move into an exchange.

Other attempts to solve the problem of matching buyers with sellers include Optimark and the proposed PDQ network. Optimark allowed market participants to express a willingness to trade across a range of quantities and prices. According to many users, Optimark failed because it was difficult to use, requiring market participants to think about their trades in a way that did not naturally express their trading objectives. PDQ Enterprises has described a virtual marketplace in which participants upload “intelligent agent” software. The intelligent agents negotiate automatically with one another on behalf of market participants.

However, the fundamental problems remain. Currently, there is no venue that allows market participants to quickly and easily express their trading objectives as a risk-cost trade-off in a way that facilitates fast, automatic crossing. Most importantly, the risk of failing to obtain a cross and the compressed execution that is required to execute the trade in the open markets with less time remaining keeps market participants from exposing their full order size to crossing networks. By exposing only part of their orders and trading the rest, they are manually mitigating the risk that their orders will fail to cross.

Optimal Execution

Delay of a trade execution incurs risk and cost. However, immediate execution incurs market impact in the form of price change caused by excess demand or supply.

In their seminal paper, Optimal Execution of Portfolio Transactions, Almgren and Chriss (2001) described a mathematical framework for analyzing the trade-off between the cost and risk of trading. Briefly, if a securities position is liquidated quickly, it incurs more cost in the form market impact. If it is liquidated slowly, it incurs more opportunity cost and price risk. A trajectory is called optimal if it describes how a security should be liquidated or accumulated over time to minimize the sum of expected costs and dollar risk, or E+λV, where λ (“risk-aversion”) is used to convert risk into dollar terms.

A market participant with zero risk-aversion would prefer a linear trajectory in which his large order is broken up into many evenly sized small orders executed over time. A market participant with a high risk aversion or a significant expectation of profits would prefer to pay a large cost to achieve fast execution. Market participants with risk aversions that fall somewhere between zero and infinity prefer front-weighted trajectories that fall somewhere between the diagonal trajectory represented by zero risk aversion and the step-like trajectory represented by immediate execution.

The conceptual framework proposed by Almgren and Chriss—and the many variations that have emerged since publication—form the basis of a growing trend in algorithmic trading. Current algorithmic trading strategies are being redefined in terms of the risk-cost tradeoff.

For example, a market participant who wants to trade in a given trading day's volume pattern wants to minimize both his expected deviation from the volume-weighted average price (VWAP) and the dispersion of deviations from VWAP scaled by his risk aversion parameter. The former is his E, while the latter is his λV. The optimal trajectory minimizes E+λV. The objective of minimizing E+λV applies to crossing networks as much as to traditional execution venues.

A single instantaneous execution of a large order minimizes crossing opportunities. For example, two orders of 10,000 shares each—a buy and a sell—may execute on a traditional exchange one second apart without crossing. The specialist or market maker is required to provide liquidity by transacting first with one party, and then the other. The parties effectively pay the market maker or specialist to act as a separate counter-party for both of them.

When the same two orders are expressed as trajectories over time, the opportunities for crossing are greatly increased. Large orders may still arrive one second apart, but if each trajectory spans, say 20 seconds, a large fraction of the first trajectory will not have been executed when the second trajectory arrives. In our system, the overlapping parts of the two trajectories would be crossed, and this crossing would occur without human intervention, completely eliminating the role of the market maker, and passing on the corresponding savings to the counter-parties.

It is important to note that stretching a trajectory out in time simply to increase the chances of crossing does not, in and of itself, represent the correct trade-off between cost and risk. An unexecuted order may have decaying expectation of profits over time and incurs price risk, in which case delaying its execution to increase the chance of crossing must be weighed against executing faster and capturing a bigger share of expected profits. Our invention solves for optimal trade-out trajectories—trade schedules that mitigate the risk of failing to cross—as well as opportunity cost and price risk—by automatically sending orders out of a crossing network to traditional execution venues.

### BRIEF SUMMARY OF THE INVENTION

The present invention is a crossing network and support software that crosses trajectories, not individual orders, and slowly trades out the uncrossed portion according to an optimal trade-out trajectory. The software considers relevant factors in planning an optimal trajectory: expected market impact, price risk, opportunity cost, and the chances of crossing within the system (and the resulting cost savings).

The invention combines several features.
Continuous crossing. Liquidity may be found, and crosses executed, at any time during trading hours.
Reserve crossing with trade-out. The risk of adverse price movement, opportunity cost, and failure to cross is mitigated by withdrawing quantities incrementally over time from the crossing network and trading them out to other marketplaces, according to a trajectory plan. The quantity still remaining (the “reserve”) in the crossing network is available for crossing.
Risk adjusted cost model with optimal trajectories. The planned tradeout trajectory is “optimal” according to a mathematical model that incorporates market factors, trader factors, stock factors, portfolio factors, and risk factors. Following the tradeout trajectory minimizes the expected costs of execution according to the model.
Opacity and anonymity. To mitigate adverse market impact, information about order limit price, order quantity, order conditions, trade quantity, trade price, and trader identity are not published. Other rules may be imposed to further limit information leakage.

The invention expresses each user's trading goal as an optimal trajectory, allows compatible trajectories to cross up to a specified amount, and executes uncrossed portions of trajectories by routing orders on behalf of the users to other liquidity venues. A trading goal is the combination of an order and auxiliary information describing the trader's preferences in the tradeoffs between cost and risk. A trajectory is a continuous plan for how the desired quantity is to be accumulated or liquidated over time. A crossed order is one in which the buyer and seller are brought together at an agreed price without resorting to the open marketplace. A crossing network is a group of traders who communicate their trading goals for the purpose of crossing their compatible orders.

To the extent that a trajectory stretches an order out over time, the chance of crossing with other orders increases. Expected trading costs are reduced (because crossed orders receive the mid-spread price and thus avoid the penalty for size incurred in traditional exchanges). Unlike the naive approach of stretching a trade out over an arbitrary period of time, our invention also explicitly addresses the risk of execution delay—that the unexecuted portion may eventually be executed at an inferior price due to random movements of the market.

The invention employs the framework of optimal execution, which provides a mathematically rigorous way of properly balancing the dual trading concerns of cost—including market impact and opportunity cost—and risk given a trader's specific preferences (see Optimal Execution of Portfolio Transactions, Almgren and Chriss, 2001). However, in addition to trading off risk against cost as described in the industry standard papers on this subject, our invention also takes into account the expected reduction in the fixed portion of temporary market impact that results from crossing rather than having to pay the spread at a traditional exchange.

The crossing of optimal continuous trajectories, with the added ability to service the trader's stated goals by executing the trajectory even when no matching orders are available by routing orders out to other liquidity destinations provides a novel comprehensive solution to the problem traders face in the markets as they exist today.

### BRIEF DESCRIPTION OF THE SEVERAL VIEWS OF THE DRAWING

In the drawings, wherein similar reference characters denote similar elements through the several views:

FIG. 1 is diagrammatic representation of the general system components in accordance with a preferred embodiment of the invention.

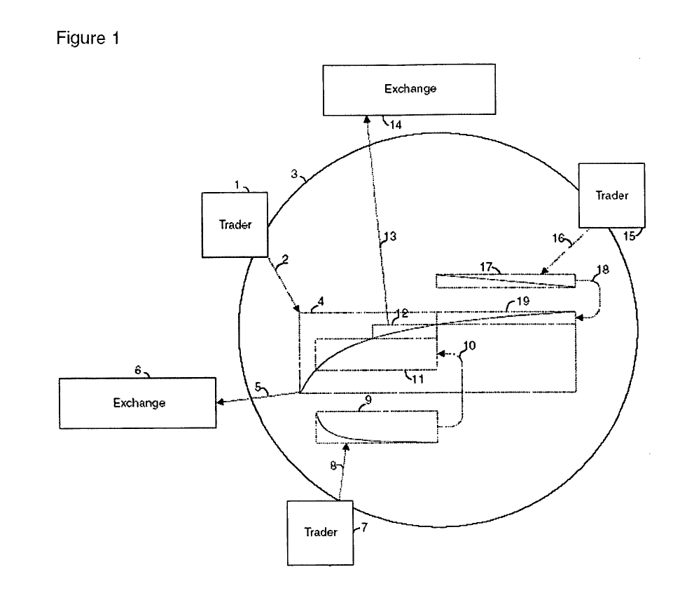

FIG. 2 shows trade-out candidate trade-out trajectories.

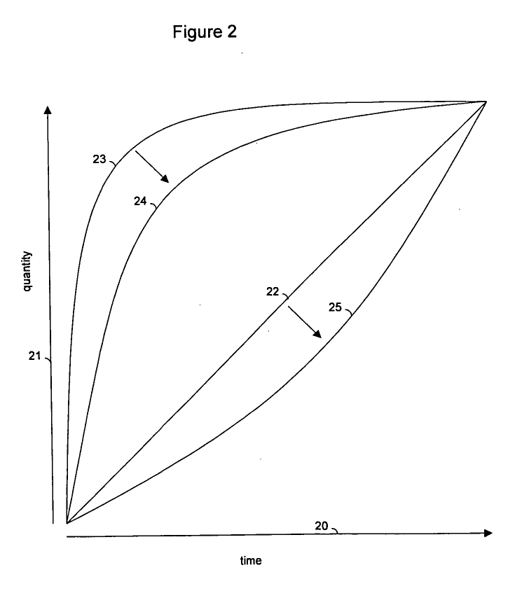

### DETAILED DESCRIPTION OF THE INVENTION

Components of the Invention
A software system capable of receiving securities orders, risk aversion parameters, and opportunity cost parameters from users.
A means of planning continuous trajectories that minimize risk-adjusted trading costs according to a mathematical framework that quantitatively trades off the conflicting concerns of market impact, price risk, and opportunity cost (such as the one described by Almgren and Chriss [2001] in Optimal Execution of Portfolio Transactions).
A database of risk and market impact characteristics for the securities being traded.
A means of allowing compatible trajectories to cross without revealing information about one user's trajectory to any other user.
A means of executing the uncrossed portion of trajectories by routing orders out to other liquidity destinations.
A means of reporting the crosses and other trading activity to users, regulatory and reporting agencies, and markets, as required.

How the Invention Is Used
A user enters his order, together with his risk aversion parameter, and, optionally his expected return per share over time into an order management system.
The order management system sends the order to our invention.
Our invention calculates an optimal trajectory for the order using a risk-cost minimization of the type described in the paper Optimal Execution of Portfolio Transactions by Almgren and Chriss (2001).
Our invention searches all other trajectories in the system to find matches for the newly calculated trajectory.
Compatible strategies—e.g., two trajectories for an arrival price benchmark on opposite sides of the same security, cross at the current mid-quote. Trajectories generated for different benchmarks—e.g., one arrival price and one volume-weighted average price—partially cross at the current mid-quote. In this case, the quantity crossed is determined by each user's risk aversion parameter and the appropriate risk-cost tradeoff.
An optimal trajectory is calculated for the uncrossed portion of the user's order. Orders are sent to other exchanges at the rate dictated by this trajectory.
The newly calculated trajectory is also added to the list of trajectories that will be searched for potential crosses as subsequent orders enter our system.
Reports regarding crossed orders and fills obtained on other exchanges are sent to users and the appropriate reporting and regulatory agencies.
Users can monitor their partial fills via their order management systems.

Benefits of the Invention
Increased number of crossed orders relative to other crossing networks.
Fast, automatic crossing of orders without manual intervention.
Reduced information leakage—users are less afraid to place large orders because information about their willingness to trade is not published in the open markets nor the crossing network.
Anonymity—institutional users can use the system without fear that their trading intentions can be inferred, since the identity of the users and even the existence of trajectories in the system is not revealed.
A large reduction of users' risk-adjusted trading costs.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

### REFERENCES

Almgren R, Chriss N (2001) Optimal execution of portfolio transactions. Journal of Risk 3:5-39.

What is claimed is:

1. A method for reducing the risk-adjusted cost of trading securities in a liquidity pool such as a crossing network or dark book, comprising:
(a) receiving a new securities order from a trader, broker, or other party;
(b) receiving auxiliary trading specifications, including without limitation a formula or parameter describing the desired risk-aversion with which the execution of the order is to be planned;
(c) formulating an optimal trading plan that divides the order into a series of suborders to be traded out of the liquidity pool over time with the objective of minimizing the risk-adjusted cost of trading, by means of an algorithm that
i. mathematically models the expected cost of market impact, opportunity cost, risk of adverse price movement, and risk of failing to find a cross for some or all of the desired quantity (thereby necessitating a compressed execution at a later time);
ii. computes the total expected risk-adjusted cost of candidate trade-out schedules (trajectories) using a trader's particular risk aversion parameter;
iii. selects an optimal trading plan, which has a minimal total expected risk-adjusted cost, from among the possible trading plans; and
iv. selects the suborders corresponding to the optimal trading plan;
(d) sending the suborders over time, to be executed according to the optimal trading plan;
(e) receiving execution reports of fills and partial fills of the suborders, from the market venues into which they were placed;
(f) receiving replacement or cancellation orders from the trader, broker, or other party;
(g) repeatedly modifying the trading plan according to (c), in response to the received execution reports (e), the received replacement or cancellation orders (f), any received updates to the auxiliary trading specifications (b), and/or the lapse of time; and
(h) sending replacement orders, cancellation orders, and new orders to follow the modified trading plans.

2. An automated system for implementing the method of claim 1, comprising
a. a computer system that receives and sends securities orders;
b. a communications network through which orders are transmitted;
c. a computer program for estimating risk-adjusted costs in a manner that takes into account the probability of crossing, and determining the trading plans accordingly; and
d. a computer program for executing the trading plans by transmitting orders to trading venues, including one or more crossing networks and one or more securities exchanges.

3. The method of claim 1 wherein one or more of the crossing networks into which portions of an order are entered perform crossing continuously throughout the trading day, rather than at predetermined times.

4. The method of claim 1 wherein the generation and evaluation of possible trading plans is subject to additional constraints, conditions, or rules, possibly including without limitation limits on the rate of trading or limits on the quantities to be traded in a trading venue.

5. The method of claim 1 wherein information about order limit price, order quantity, order conditions, trade price, trade quantity, and/or trader identity is concealed from traders and other parties.

6. The method of claim 1 wherein one or more orders are linked together in a basket with constraints on their relative execution rates, quantities, and prices, and wherein the generation and evaluation of possible trading plans is subject to the constraints.

7. The method of claims 1 and 6 wherein information about the characteristics of a basket—such as the covariance of the component stocks—is used in the search for optimal trade-out trajectories.
